(19) United States
(12) Patent Application Publication
(10) Pub. No.: US 2009/0313005 A1
(43) Pub. Date: Dec. 17, 2009

(54) METHOD FOR ASSURED LINGUAL TRANSLATION OF OUTGOING ELECTRONIC COMMUNICATION

(75) Inventor: Joseph Jaquinta, Medford, MA (US)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 12/137,165

(22) Filed: Jun. 11, 2008

(51) Int. Cl. G06F 17/28

(52) U.S. Cl. 704/2

(57) ABSTRACT

A method for translating electronic text, the method includes: receiving electronic text in a first language from an originating sender; displaying the electronic text in the first language; translating the electronic text from the first language into a first translation in a second language; displaying the first translation; translating the first translation back into the first language to form a double translation; displaying the double translation; sending the first translation to one or more recipients upon a determination by the originating sender that the double translation is acceptable; and upon a determination by the originating sender that the double translation is unacceptable, receiving the electronic text in the first language modified by the originating sender, and generating a new first and double translation in response to the modifications.

### BACKGROUND OF THE INVENTION

1. Field of the Invention

This invention relates generally to electronic text communications, and more particularly to a method for translating electronic communications.

2. Description of the Related Art

Electronic communication, such as electronic mail (email) and instant messaging (IM), has become a central feature of modern life and users have come to expect to receive electronic mail messages and instant messages at any time and in virtually any place. For example, during the course of one day of travel, a user may receive electronic communications at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic communication messaging has provided an efficient method to communicate information. The utilization of the Internet to distribute electronic communications has connected people around the world to form a so-called World Wide Web. In fact electronic messaging with its near instantaneous delivery from sender to receiver has made it the preferred method of personal and business communication where hardcopy signatures are not required. In addition the ease of use and minimal cost of distribution has led to mass email to large distribution lists, as well as using email and IM as a broad collaborative tool.

### SUMMARY OF THE INVENTION

Embodiments of the present invention include a method for translating electronic text, wherein the method includes: receiving electronic text in a first language from an originating sender; displaying the electronic text in the first language; translating the electronic text from the first language into a first translation in a second language; displaying the first translation; translating the first translation back into the first language to form a double translation; displaying the double translation; sending the first translation to one or more recipients upon a determination by the originating sender that the double translation is acceptable; and upon a determination by the originating sender that the double translation is unacceptable, receiving the electronic text in the first language modified by the originating sender, and generating a new first and double translation in response to the modifications.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method for improved translation of electronic text communications.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary graphical user interface (GUI) for carrying out embodiments of the invention.

FIG. 2 illustrates a typical translation method flow according to embodiments of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

The explosive growth in the use of electronic mail (email) and instant messaging (IM) between people across the globe via the World Wide Web on the Internet has intensified the need for translating electronic messages between people into their native languages.

Presently, automated language translation utilizes forms of machine translation technology. Machine translation utilizes computer software to perform a lingual translation of text. However, since language is a very complicated subject there are severe limitations on the accuracy of machine translation, and a seventy percent translation accuracy rate is generally considered acceptable. Thus, machine translation technology is most often described as a “gisting” technology, in other words, machine technology may be used to get the meaning or “gist” of a section of text that a person would otherwise have no knowledge of. For example “IBM hat zusammen mit einer Reihe von IT-Professionals das OpenPower Project als neue Entwickler-Community ins Leben gerufen.”->“IBM brought open power the Project together with a set of IT Professionals as new developer Community into being.”

Because machine translation technology is less than one hundred percent accurate, machine translation is usually only recommended for use on incoming information. Machine translation works best on very formal, structurally perfect, and simple text. In such cases it can even achieve 100% success. For example “Ich bin spät.” translates into “I am late.” In such circumstances a recipient easily understands the resulting translated text. However, a typical user does not speak the target language, and they would not know how successful a translation of the target language is. Thus machine translation would be used to read an incoming message in a language that the recipient does not understand, but machine translation would not be recommended for writing a message in a language that is non-native to the user. With the inherent inaccuracies of machine translations, and a probable lack of understanding of the language that the user wishes to translate into, the user would not know if the information they are sending is correct.

In order to provide users with a means to send outgoing electronic communications in a non-native language, embodiments of the invention perform a double translation on outgoing text. The electronic message text is first translated from the sender's language, to the recipient's language, and the electronic message is then translated again from the recipient's language back to the sender's language.

Even though each translation introduces an error rate, and the double translation may be less accurate than the single translation (for example, if a machine translation is seventy percent accurate, and simple statistical combinations are assumed, the resulting double translation will only be forty nine percent accurate), with embodiments of the invention, the electronic message sender is informed of the double translation, and may make their own assessment as to how understandable the message is. Although the sender may not know the quality of the singly translated text, since they may not speak the language, the sender does know that the singly translated text is at least better or equal to the doubly translated text. If the sender deems the doubly translated text as satisfactory, the sender will transmit the singly translated text with a level of confidence that it is no worse than the doubly translated text. In the event the sender is not satisfied with the double translation, the sender may change the originating source text to a simpler form that may translate better into the target language of the intended recipient.

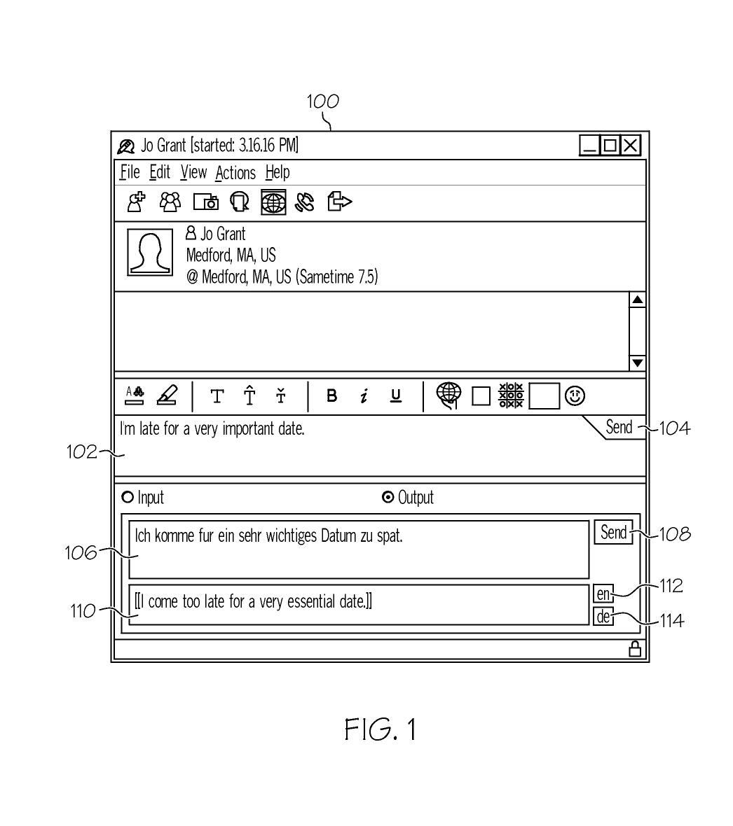

FIG. 1 illustrates an exemplary graphical user interface (GUI) for carrying out embodiments of the invention. The GUI 100 of FIG. 1 is configured for instant messaging (IM); however it is noted that embodiments of the invention may also be configured for email, or any other form of communication involving electronic text composed in an interactive environment. The GUI 100 has a composition area 102 that is used to compose an instant message for sending, and has a send button 104 that when depressed sends the IM as initially composed to one or more intended receivers. A single translation area 106 displays a translation of the initially composed message from composition area 102 in the language of the intended receivers (German in the present example). A send translation button 108 is used to send the translated message displayed in translation area 106 to the one or more receivers. The double translation area 110 contains a retranslation of the initially translated message displayed in translation area 106 back into the language of the sender (English in the present example). Indicator 112 displays the sender's language (‘en’ for English), while indicator 114 displays the language of the recipient (‘de’ for German). The indicators (112, 114) may also be used to change/select the composing and receiving languages of the electronic communication.

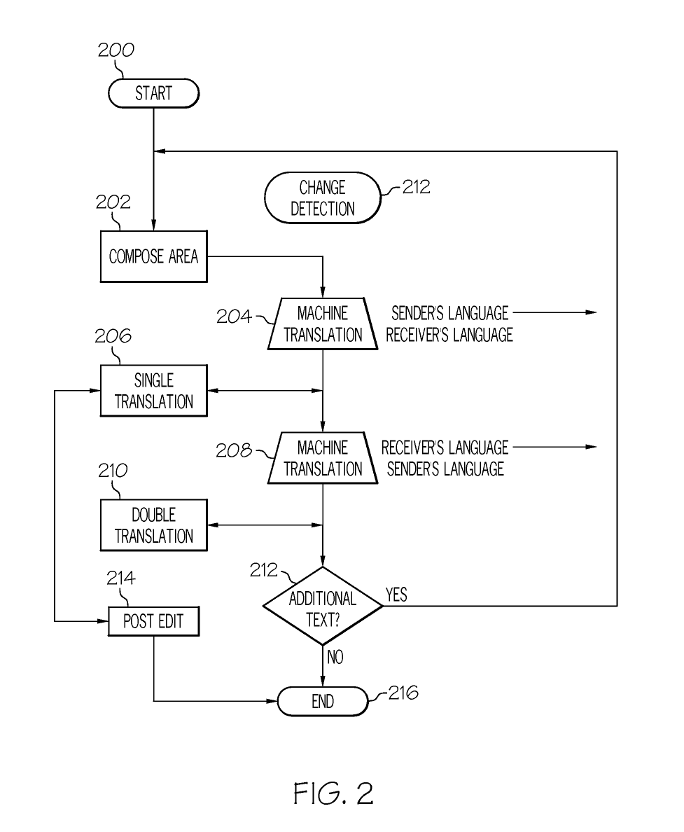

FIG. 2 illustrates a typical translation method flow according to embodiments of the invention. The process starts (block 200) with an outgoing message being composed (block 202) in the composition area 104. If the sender wishes to engage in monolingual chat, they may click the send button 104 and the text composed (block 202) will be sent, as is. The system, of embodiments of the invention, is configured to detect change (block 212). The composition area 104 indicates when the text contents are changed. A thread of execution monitors in the change detector (block 212) continuously observe the composition area 104, and when no change to the contents has been detected for a predetermined period of time, the composed text string is registered and the translation flow described in FIG. 2 is automatically invoked. Alternative embodiments may use other mechanisms; such as an actual button the sender presses or selects, or anything equivalent to start the translation process. Change may also be indicated in the event the user specifies that they are sending text in a different language (112), or they wish the receiver to receive the text in a different language (114). Both of these indicators (112, 114) may be used to trigger a change in the same manner as if the text in the composition area (104) is changed.

Continuing with the flowchart of FIG. 2, in the event a change is detected the text is first retrieved from the composition area 104, and is then passed to a machine translation service (block 204), with an indication that the text is to be translated from the specified sender's language (112) to the receiver's language (114). The resultant text is the single translation (block 206), and is displayed in the single translation area (102). Subsequently, the single translated text is passed back to the machine translation service (block 208) with an indication that the single translated text is to be translated from the specified receiver's language (114) back into the sender's language (112). The resultant text from this operation is the double translation (block 210) that is displayed in the double translation area 110. In the event there are additional text strings in the sender's electronic communication (decision block 212 is Yes), the process repeats with the entry of a text string in the composition area 102 (block 202), or else the process concludes (block 216). The sending composer may review both the single translation (block 206) and the double translation (block 210). In the event the sending composer has some skill in the recipient's language (114), the sender may choose to post-edit (block 214) the singly translated text in the display area (106). If the sender post-edits the singly translated text (block 214) to their satisfaction, the sender may press the send translation button 108 and singly translated text 106 will be sent to the receiver. Otherwise the sender may examine the double translation 110. In the event the double translation 110 is clear enough, the sender may press the send translation button 108 to send the electronic message to the receiver, or they can modify the text in the composition area 102 to simplify or alter the language and observe the new translations.

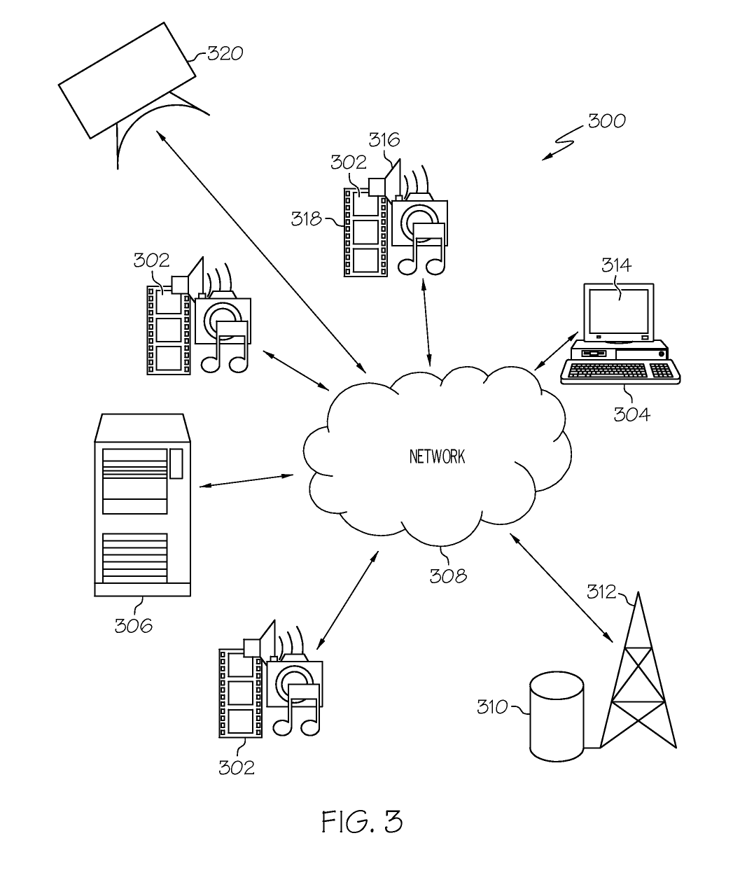

FIG. 3 is a block diagram of an exemplary system 300 configured for improved translating of electronic messages. The system 300 includes multimedia devices 302, and desktop computer devices 304 configured with display capabilities 314. The multimedia devices 302 may be mobile communication and entertainment devices, such as cellular phones and mobile computing devices that are wirelessly connected to a network 308. The multimedia devices 302 have video displays 318 and audio outputs 316. The multimedia devices 302 and desktop computer devices 304 may be configured with software with a GUI for carrying out the translation method of embodiments of the invention. The network 308 may be any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 310 and antenna 312. In a preferred embodiment, the network 308 is a LAN and each remote device 302 and desktop device 304 executes a user interface application (e.g., web browser) to contact the server system 306 through the network 308. Alternatively, the remote devices 302 and 304 may be implemented using a device programmed primarily for accessing network 308 such as a remote client.

The translation software, of embodiments of the invention, may be resident on the individual multimedia devices 302 and desktop computers 304, or stored within the server 306 or cellular base station 310.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for translating electronic text, wherein the method comprises:
receiving electronic text in a first language from an originating sender;
displaying the electronic text in the first language;
translating the electronic text from the first language into a first translation in a second language;
displaying the first translation;
translating the first translation back into the first language to form a double translation;
displaying the double translation;
sending the first translation to one or more recipients upon a determination by the originating sender that the double translation is acceptable; and
upon a determination by the originating sender that the double translation is unacceptable, receiving the electronic text in the first language modified by the originating sender, and generating a new first and double translation in response to the modifications.

2. The method of claim 1, wherein upon a determination by the originating sender that the double translation is unacceptable, receiving from the originating sender a modification of the first translation, and generating a new double translation in response thereto.

3. The method of claim 1, wherein a graphical user interface (GUI) is configured to accept input of the electronic text and display the first language, the first translation, and the double translation.

4. The method of claim 3, wherein the first translation and double translation are generated in response to the originating sender pressing or selecting a button on the GUI.

5. The method of claim 1, wherein the first translation and double translation are generated automatically after detecting a predetermined period of inactivity after entry of the first language.
